(19) United States
(12) Patent Application Publication
(10) Pub. No.: US 2025/0244611 A1
(43) Pub. Date: Jul. 31, 2025

(54) CONTACT LENS ASSEMBLIES AND METHODS OF MANUFACTURE THEREOF

(71) Applicant: CooperVision International Limited, Fareham (GB)

(72) Inventors: Robert OAG, Southampton (GB); Rachel MARULLO, Oakland, CA (US); Robert TURNER, Chandler's Ford (GB); Mark CHALMERS, Bournemouth (GB)

(73) Assignee: CooperVision International Limited, Fareham (GB)

(21) Appl. No.: 19/037,305

(22) Filed: Jan. 27, 2025

Related U.S. Application Data
(60) Provisional application No. 63/627,330, filed on Jan. 31, 2024.

(51) Int. Cl. G02C 7/04; G02B 1/04

(52) U.S. Cl. CPC G02C 7/04; G02B 1/043

(57) ABSTRACT

A method of manufacturing a contact lens assembly is disclosed. The method comprises bonding an anterior surface of a first lens member to a posterior surface of a second lens member; and then machining an anterior surface of the second lens member and a posterior surface of the first lens member. Lens members are machined to produce datum surfaces on both sides of the member, the datum surfaces defining between them a reference thickness. A contact lens assembly, and contact lens members manufactured using said method are also disclosed.

This application claims the benefit under 35 U.S.C. § 119 (e) of prior U.S. Provisional Patent Application No. 63/627,330, filed Jan. 31, 2024, which is incorporated in its entirety by reference herein.

The present disclosure concerns contact lens assemblies, more particularly, but not exclusively, contact lens assemblies manufactured by bonding together first and second lens members.

### BACKGROUND

It is often desirable to produce contact lens assemblies by bonding together first and second lens members so that one or more components, for example electronic components, optical components and/or liquid crystal layers can be located between the first and second lens members.

Such lens assemblies may be produced by machining (e.g. cutting, for example using a lathe) one or more lens member blanks to shape and then bonding said lens member blanks together, optionally with one or more components, coatings or liquid fills (for example liquid crystal layers) between them. During machining, the lens member blanks are mounted on a mandrel (or arbour) using wax.

When using such methods, it is difficult to accurately position the blanks on the mandrel and achieve a constant thickness of wax. It is also difficult to accurately position the second lens member and other components relative to the first lens member for the bonding step. This can lead to errors in the shape of the contact lens assembly as a result of components being out of position or tilted relative to the mandrel during cutting and/or being out of position or tilted relative to each other during assembly. It would be advantageous to reduce the rate of such errors during the manufacturing process.

The present disclosure seeks to mitigate the above-mentioned problems. Alternatively or additionally, the present disclosure seeks to provide improved processes for the manufacture of contact lens assemblies.

### SUMMARY

In a first aspect, the present disclosure provides a method of manufacturing a contact lens assembly, the method comprising: bonding an anterior surface of a first lens member to a posterior surface of a second lens member; and then machining an anterior surface of the second lens member and a posterior surface of the first lens member.

In a second aspect, the present disclosure provides a method of manufacturing a contact lens assembly, the method comprising the steps of:
machining a region of an anterior surface of a first lens member to produce a first datum surface and machining a region of a posterior surface of the first lens member to provide a second datum surface, the first and second datum surfaces defining between them a first reference thickness; and
machining a region of an anterior surface of a second lens member to produce a third datum surface and machining a region of a posterior surface of the second lens member to provide a fourth datum surface, the third and fourth datum surfaces defining between them a second reference thickness; and
bonding an anterior surface of the first lens member to a posterior surface of the second lens member to produce a contact lens assembly; and then
machining the anterior surface of the second lens member and/or the posterior surface of the first lens member.

It will of course be appreciated that features described in relation to one aspect of the present disclosure may be incorporated into other aspects of the present disclosure. For example, the method of the disclosure may incorporate any of the features described with reference to the apparatus of the disclosure and vice versa.

### DESCRIPTION OF THE DRAWINGS

Example embodiments will now be described, by way of example only, with reference to the accompanying schematic drawings, of which:

FIG. 1 is a cross-sectional side view of a lens member according to an example embodiment of the present disclosure.

FIG. 2A shows a posterior lens member according to an example embodiment of the present disclosure, formed by machining the front surface of the lens member of FIG. 1.

FIG. 2B shows a close up of a portion of the main body of the lens member of FIG. 2A.

FIG. 3A shows an anterior lens member according to an example embodiment of the present disclosure, formed by machining the front surface of the lens member of FIG. 1.

FIG. 3B shows a portion of a close up of the main body of the lens member of FIG. 3A.

FIG. 4A shows a contact lens assembly according to an example embodiment of the present disclosure.

FIG. 4B shows a close up of a region of the contact lens assembly of FIG. 4A.

FIG. 5 shows the contact lens assembly of FIG. 4A after further machining steps.

FIG. 6 shows the contact lens assembly of FIG. 5 after further machining steps.

FIG. 7 shows the contact lens assembly of FIG. 6 after further machining steps.

FIG. 8 is a flow chart showing a first example method of manufacturing a contact lens assembly in accordance with the present disclosure.

FIG. 9 is a flow chart showing a second example method of manufacturing a contact lens assembly in accordance with the present disclosure.

### DETAILED DESCRIPTION

According to a first aspect of the present disclosure, there is provided a method of manufacturing a contact lens assembly, the method comprising: bonding an anterior surface of a first lens member to a posterior surface of a second lens member; and then machining an anterior surface of the second lens member and a posterior surface of the first lens member.

Thus, the anterior and posterior surface of the resulting contact lens assembly is machined after the first and second lens members have been bonded together. Machining the anterior surface of the second lens member and the posterior surface of the first lens member after the lens members are bonded together may reduce the risk of any error in misalignment between the two lens members impacting on the post-machining shape of the contact lens assembly.

The contact lens assembly may be configured such that, in use, the anterior surface of a lens member is positioned further from the surface of the eye than the posterior surface of a lens member. Thus, it may be that when used to describe a surface “anterior” refers to a surface facing away from the eye when the contact lens assembly is in use on an eye. Similarly, it may be that when used to describe a surface “posterior” refers to a surface facing toward the eye when the contact lens assembly is in use on an eye.

It may be that the posterior surface of the first lens member is machined such that the posterior surface comprises a concave surface region, for example a bowl-shaped region. It may be that the anterior surface of the second lens member is machined such that the anterior surface comprises a convex surface region, for example a dome-shaped region. It may be that the step of machining the anterior surface of the second lens member and the posterior surface of the first lens member after the lens members have been bonded together comprises machining said surfaces to produce a final shape of the contact lens assembly. It may be that the step of machining the anterior surface of the second lens member and the posterior surface of the first lens member after the lens members have been bonded together comprises shaping the surfaces to define at least part of the optical zone of a lens.

It may be that the step of bonding an anterior surface of the first lens member to a posterior surface of the second lens member to produce a contact lens assembly comprises applying an adhesive to the anterior surface of the first lens member and/or the posterior surface of the second lens member and then bringing the first and second lens members together, for example until the adhesive has cured and/or the lens members are held in a fixed relationship.

It may be that machining a surface of a lens member comprises removing material from the lens member using a machine tool, for example a lathe.

It may be that prior to any of the machining steps of the present disclosure each lens member comprises a main body and a spigot. It may be that the spigot is connected to the main body at one end. It may be that the spigot comprises an elongate member, for example being substantially cylindrical in cross-section, such that the spigot can be received in the chuck or collet of a machine tool, for example a lathe, and thereby secure the lens member for machining. Thus, the method may comprise mounting a lens member for machining using the spigot, for example by inserting the spigot into the chuck or collet of a lathe or other machine tool. It may be that prior to any of the machining steps of the present disclosure, the main body is substantially cylindrical. It may be that prior to any of the machining steps of the present disclosure, the main body has a front surface on the opposite side of the main body to the spigot, and a rear surface on the opposite side of the main body to the front surface (i.e. the same side of the main body as the spigot). It may be that the front and/or rear surfaces are substantially planar prior to any of the machining steps of the present disclosure. It may be that the main body has a diameter and a thickness. It may be that prior to any of the machining steps of the present disclosure the diameter of the main body is greater than the diameter of the spigot and/or the thickness of the main body is less than the length of the spigot.

It may be that the step of machining an anterior surface of the second lens member and a posterior surface of the first lens member comprises removing the spigot of the first lens member and/or the spigot of the second lens member. The method may comprise removing the spigot and then machining to the anterior or posterior surface to provide a convex or concave surface as described above.

It may be that, for each of the first and second lens member, the step of machining the anterior surface of the second lens member and the posterior surface of the first lens member comprises a first stage in which the spigot of the lens member is removed; and a second stage in which the surface of the lens member is machined to provide a concave or convex surface, for example machined to its final shape. For example, the method may comprise a first stage in which the first lens member is machined to remove its spigot; and a second stage in which the posterior surface of the first lens member is machined to its concave/final shape. The method may comprise a third stage in which the second lens member is machined to remove its spigot; and a fourth stage in which the anterior surface of the second lens member is machined to its convex/final shape. The third and fourth stages may be carried out before, after or simultaneously with, the first and second stages. The step of machining a lens member to remove its spigot may be carried out on a different machine tool to the step of machining the surface of the lens member to its final shape. For example, removal of the spigots may require less accuracy than other machining steps, and therefore the removal step may be carried out on a non-optical lathe. Thus, the step of removing the spigot may be carried out on a non-optical machine tool while the step of machining the surface is carried out on an optical machine tool (e.g. a machine tool capable of achieving optical-grade surfaces). A non-optical machine tool may be capable of achieving tolerances in the order of +/−0.02 mm, while an optical machine tool can achieve tolerances in the order of +/−0.002 mm. Typically, optical machine tools will be more expensive and/or remove material at a lower rate than non-optical machine tools. Accordingly, reducing the amount of machining that must be carried out on e.g. an optical lathe, may reduce the cost and/or increase the efficiency of the manufacturing process.

It may be that during machining of the anterior surface of the second lens member, the contact lens assembly is mounted on the machine tool using the spigot of the first lens member. Alternatively, it may be that during machining of the anterior surface of the second lens member, the contact lens assembly is mounted on the machine tool using a mandrel, for example with the posterior surface of the first lens member adjacent the front surface of the mandrel. This may be the case where the spigot of the first lens member has been removed before machining of the anterior surface.

It may be that during machining of the posterior surface of the first lens member, the contact lens assembly is mounted on the machine tool using the spigot of the second lens member. Alternatively, it may be that during machining of the posterior surface of the first lens member, the contact lens assembly is mounted on the machine tool using a mandrel, for example with the anterior surface of the first lens member adjacent the front surface of the mandrel. This may be the case where the spigot of the second lens member has been removed before machining of the posterior surface.

It may be that the method further comprises bonding the anterior surface of the first lens member to the posterior surface of the second lens member; and then mounting the first and second lens members so bonded on a (first) mandrel, before the step of machining the anterior surface of the second lens member and the posterior surface of the first lens member is carried out. When bonded together, the first and second lens member may be referred to as a contact lens assembly. Thus, the method may comprise bonding the first and second lens members together to produce a contact lens assembly, and then mounting the contact lens assembly on a (first) mandrel.

It may be that the step of machining the anterior surface of the second lens member and the posterior surface of the first lens member comprises machining the posterior surface of the first lens member and then machining the anterior surface of the second lens member. Thus, it may be that the posterior surface of the first lens member is machined before the anterior surface of the second lens member.

Machining the (concave) posterior surface before the (convex) anterior surface may provide easier access for machining the anterior surface, as compared to the ease of access for machining the posterior surface if the anterior surface is cut first.

It may be that the method comprises machining the anterior surface of the first lens member and the posterior surface of the second lens member, before bonding the anterior surface of the first lens member to the posterior surface of the second lens member. Thus, it may be that internal features of the contact lens assembly are machined prior to the lens members being bonded together. It may be that the anterior surface of the first lens member is machined such that the anterior surface comprises a convex surface region. It may be that the posterior surface of the second lens member is machined such that the posterior surface comprises a concave surface region. It may be that each lens member is mounted on the machine tool using its spigot during machining of the anterior surface of the first lens member and/or the posterior surface of the second lens member.

After machining the anterior surface of the first lens member and the posterior surface of the second lens member and/or before bonding the lens members together, it may be that the method comprises a step of applying one or more coatings or layers (e.g. liquid crystal layers) to the anterior surface of the first lens member and/or the posterior surface of the second lens member and/or a step of locating one or more components on the anterior surface of the first lens member and/or the posterior surface of the second lens member. The method may comprise bonding the lens members together such that said coating, layer and/or component is located between the first and second lens members.

According to a second aspect of the present disclosure, there is provided a method of manufacturing a contact lens assembly. The method may comprise the steps of: machining a region of an anterior surface of a first lens member to produce a first datum surface and/or machining a region of a posterior surface of the first lens member to provide a second datum surface, wherein the first and second datum surfaces define between them a first reference thickness; and/or machining a region of an anterior surface of a second lens member to produce a third datum surface and/or machining a region of a posterior surface of the second lens member to provide a fourth datum surface, wherein the third and fourth datum surfaces define between them a second reference thickness. The method may then comprise bonding an anterior surface of the first lens member to a posterior surface of the second lens member to produce a contact lens assembly. The method may then comprise machining the anterior surface of the second lens member and/or the posterior surface of the first lens member (for clarity, these steps of machining after the first and second lens members have been bonded together may be referred to hereafter as ‘post-bonding’ machining steps).

Thus, each of the first and second lens members may be provided with a reference thickness and datum surfaces on both sides of the member, prior to being bonded together. Provision of the datum surfaces may facilitate accurate positioning of the lens members/lens assembly during subsequent manufacturing steps, and thereby reduce the risk of errors in the final shape of the contact lens assembly. Additionally or alternatively, having a known reference thickness on each lens member may allow for the resulting contact lens assembly to have a known reference thickness, and thereby facilitate increased accuracy of any subsequent machining.

The method of the second aspect may have any of the features described above with respect to the first aspect, and vice versa.

It may be that the first and third datum surfaces are on the front surface of the first lens member and second lens member respectively (i.e. the surface of the lens member on the opposite side of the main body to the spigot, prior to any machining step). It may be that the second and fourth datum surfaces are on the rear surface of the first lens member and second lens member respectively. It may be that the first, second, third and/or fourth datum surfaces are located radially outboard of the diameter of the finished contact lens.

It may be that post-bonding machining of the anterior surface of the second lens member comprises mounting the contact lens assembly on a (second) mandrel with the second datum surface abutting a front surface of the mandrel and then machining the anterior surface while the contact lens assembly is mounted on the mandrel. It may be that post-bonding machining of the posterior surface of the first lens member comprises mounting the contact lens assembly on a (third) mandrel with the third datum surface abutting a front surface of the mandrel and then machining the posterior surface while the contact lens assembly is mounted on the mandrel. Thus, provision of the second and/or third datum surfaces may improve the accuracy and/reliability with which the contact lens assembly is positioned on the mandrel and thereby reduce the risk of machining errors.

Post-bonding machining of the posterior surface of the first lens member may comprise removing the spigot of the first lens member, and then machining the posterior surface to a convex/its final shape. Post-bonding machining of the anterior surface of the second lens member may comprise removing the spigot of the second lens member, and then machining the posterior surface to a concave/its final shape. Post-bonding machining of the anterior or posterior surface may be carried out in a two-stage process as discussed above in connection with the first aspect.

The or each mandrel may comprise a main body having a front surface, and a spindle extending from the main body on the opposite side of the body to the front surface. The mandrel may be configured such that, in use, a lens member or contact lens assembly can be mounted to the front surface of the mandrel, for example using wax, for machining. For example, the mandrel may comprise one or more recesses configured to receive a portion of the lens member and/or contact lens assembly. It may be that the spindle is configured to be received in the collet or chuck of a machine tool. Thus, the mandrel can be used to mount a lens member and/or contact lens assembly on a machine tool for machining. The front surface of the mandrel may comprise a planar region configured to abut a datum surface of the contact lens assembly during post-bonding machining. The front surface of the mandrel may comprise a machining channel, the mandrel being configured such that said channel receives a portion of the contact lens assembly when said datum surface abuts said planar region, without said portion of the contact lens assembly contacting the portion of the front surface of the mandrel defining said channel. The machining channel may be configured to receive a portion of the contact lens assembly that forms the edge of the finished contact lens. Such a recess may facilitate machining of the edge of the lens by allowing a machine tool access to the surface of the contact lens assembly adjacent the mandrel. Thus, the method may comprise post-bonding machining the edge region of the contact lens while said region is received within said channel and while a datum surface of the contact lens assembly abuts the planar region.

It may be that while the contact lens assembly is mounted on a machine tool for post-bonding machining of the anterior surface of the second lens member, material is also removed from the first lens member. For example, the step of post-bonding machining the anterior surface of the second lens member may comprise removing the entire thickness of the second lens member in a region, and machining the anterior surface of the first lens member in said region to provide a fifth datum surface. Thus, the method may comprise, when post-bonding machining the anterior surface of the contact lens assembly, removing the entire thickness of the second lens member in a region, and then machining the anterior surface of the first lens member in said region to provide a fifth datum surface. It may be that between them, the second and fifth datum surfaces define a further reference thickness. It may be that for post-bonding machining of the posterior surface of the first lens member, the contact lens assembly is mounted on a mandrel with the fifth datum surface abutting the front surface of the mandrel. Use of such a fifth datum surface may further increase the accuracy and/or reliability with which the final shape of the contact lens assembly is achieved.

It may be that while the contact lens assembly is mounted on a machine tool for post-bonding machining of the posterior surface of the first lens member, material is also removed from the second lens member. For example, the step of post-bonding machining the posterior surface of the first lens member may comprise removing the entire thickness of the first lens member in a region, and machining the posterior surface of the second lens member in said region to provide a sixth datum surface. Thus, the method may comprise, when post-bonding machining the posterior surface of the contact lens assembly, removing the entire thickness of the first lens member in a region, and then machining the posterior surface of the second lens member in said region to provide a sixth datum surface. It may be that between them, the third and sixth datum surfaces define a further reference thickness. It may be that for post-bonding machining of the anterior surface of the second lens member, the contact lens assembly is mounted on a mandrel with the sixth datum surface abutting the front surface of the mandrel. Use of such a sixth datum surface may further increase the accuracy and/or reliability with which the final shape of the contact lens assembly is achieved.

It may be that the method comprises mounting the first lens member or the second lens member on a machine tool. It may be that said lens member remains in place on said machine tool throughout the steps of machining the surfaces of the lens member to provide the datum surfaces. It may be that the first lens member remains mounted on the same machine tool throughout the steps of machining a region of the anterior surface of the first lens member to produce a first datum surface and machining a region of the posterior surface of the first lens member to provide a second datum surface. It may be that the second lens member remains mounted on the same machine tool throughout the steps of machining a region of the anterior surface of the second lens member to produce a third datum surface and machining a region of the posterior surface of the second lens member to provide a fourth datum surface. Retaining the lens member in place while both reference surfaces are cut may allow for the accurate and/or reliable production of the reference thickness even if the lens member is tilted or otherwise misaligned to the mandrel. Additionally, or alternatively, more accurate/reliable production of the reference thickness reduces the risk of machining errors in subsequent machining steps. It may be that the lens member is not removed or demounted from the machine tool during said steps of machining the anterior and posterior surface to provide the datum surfaces. It may be that the first and second datum surfaces and/or the third and fourth datum surfaces are machined without demounting the relevant lens member from the machine tool. It may be that the first and second datum surfaces are produced as part of the same (continuous) cutting operation. It may be that the third and fourth datum surfaces are produced as part of the same (continuous) cutting operation. For example, the method may comprise cutting the first and second datum surfaces, or the third and fourth datum surfaces, while keeping the cutting tool in continuous contact with the lens member. It may be that the method comprising cutting one of the datum surfaces, the edge of the lens member and the other of the datum surfaces, while keeping the cutting tool in continuous contact with the lens member. The first lens member and second lens member may be mounted on and/or machined using the same machine tools (e.g. a first machine tool) or different machine tools (e.g. the first lens member may be mounted/machined on a first machine tool, while the second lens member is mounted/machined on a second machine tool). Mounting a lens member on a machine tool for machining of the datum surfaces may comprise a spigot of said lens member being received in a chuck or collet of said machine tool and/or mounting the lens member on a mandrel.

It may be that the anterior surface of the first lens member is bonded to the posterior surface of the second lens member such that the first reference thickness and second reference thickness are aligned to define a third reference thickness between the second datum surface and the third datum surface.

Thus, the first and second reference thickness may be used to ensure the contact lens assembly has a known reference thickness after bonding, which may increase the accuracy and/or reliability of any subsequent machining steps. This may be particularly the case where the first and second lens members were shaped without the lens members being removed from the mandrel/machine tool. Thickness may be defined as the distance between opposite sides of a piece (e.g. a lens member or contact lens assembly), measured parallel to the longitudinal axis of said piece.

It may be that the anterior surface of the first lens member is bonded to the posterior surface of the second lens member with the first datum surface contacting, for example directly contacting, the fourth datum surface. This may further increase the accuracy to which, and/or reliability with which, the third reference thickness is achieved.

It may be that the first, second, third, fourth, fifth (if present) and/or sixth (if present) datum surfaces are annular when viewed in plan, when first machined.

According to a third aspect of the disclosure, there is provided a contact lens assembly manufactured according to the method of the first and/or second aspects.

According to a fourth aspect of the present disclosure, there is provided a first lens member comprising first and second datum surfaces and/or a second lens member comprising third and fourth datum surfaces as described above. The first and second lens members of the fourth aspect may have any of the features described above with reference to the first to third aspects, and vice versa.

According to a fifth aspect of the present disclosure, there is provided a contact lens assembly comprising a first lens member and a second lens member, for example in accordance with the fourth aspect. The contact lens assembly of the fifth aspect may have any of the features described above with reference to the first to fourth aspects, and vice versa.

The contact lens assembly of the present disclosure may form the whole or a portion of a contact lens. As used herein, “contact lens” means an ophthalmic lens that can be placed on the eye of a person. It will be appreciated that such a contact lens will provide clinically acceptable on-eye movement and not bind to the eye or eyes of a person. The contact lens may be a corneal lens (e.g. a lens that rests on the cornea of the eye), or a scleral lens (e.g. a lens that rests on the sclera of the eye). The contact lens may be a soft contact lens, such as a hydrogel contact lens or a silicone hydrogel contact lens. The contact lens may be a rigid gas permeable contact lens. The contact lens, contact lens assembly, first lens member and/or second lens member may comprise, essentially consist, consist, and/or be made, of polymethyl methacrylate (PMMA).

The contact lens of the present disclosure may be circular in shape. The contact lens may have a diameter from 4 mm to 22 mm inclusive, for example from 10 mm to 22 mm inclusive. The contact lens may have an optic zone. The optic zone corresponds to the portion of the contact lens that overlays the pupil of an eye, and the optic zone refracts light in such a way as to provide the desired visual benefit to the person wearing the contact lens. The optic zone may be circular in shape. The optic zone may have a diameter of from 2 mm to 10 mm inclusive. In some embodiments, the contact lens has a diameter from 13 mm to 16 mm inclusive, for example a diameter of 14 mm to 15 mm inclusive, and the optic zone has a diameter from 5 mm to 9 mm inclusive, for example from 8 mm to 9 inclusive mm. The contact lens may be rotationally symmetric in the optic zone.

Prior to any machining step, the main body of a lens member may have a diameter from 23 mm to 25 mm inclusive, for example from 23 mm to 24 mm inclusive. Prior to any machining step, the main body may have a thickness from 6 mm to 7 mm inclusive, for example from 6.5 mm to 7 mm inclusive. The spigot may have a diameter of from 8 mm to 10 mm inclusive, for example from 9 mm to 10 mm inclusive. The spigot may have a length of from 9 mm to 11 mm, for example from 10 mm to 11 mm inclusive. Prior to any machine step, the first and second lens members may be identical.

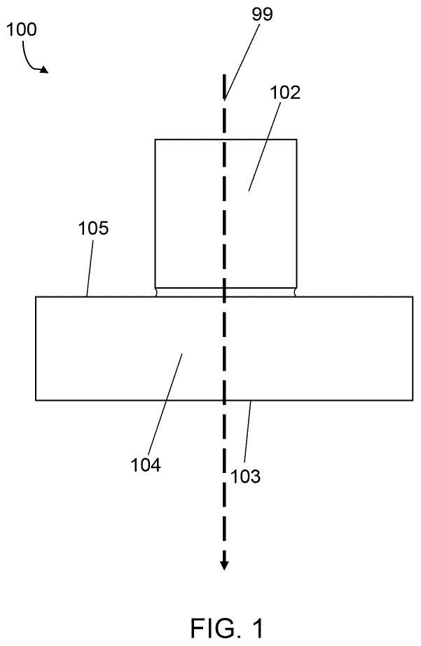

FIG. 1 is a cross-sectional side view of a lens member 100 at the start of the manufacturing process of the present disclosure. The lens member comprises a spigot 102 extending from a main body 104. The main body 104 has a front surface 103 on the opposite side of the main body 104 to the spigot 102. The main body 104 has a rear surface 105 on the opposite side of the main body 104 to the front surface 103. The front surface 103 and rear surface 105 are planar. The spigot 102 and main body 104 are cylindrical and rotationally symmetric about the longitudinal axis (denoted by dashed line 99 in FIG. 1) of the lens member 100.

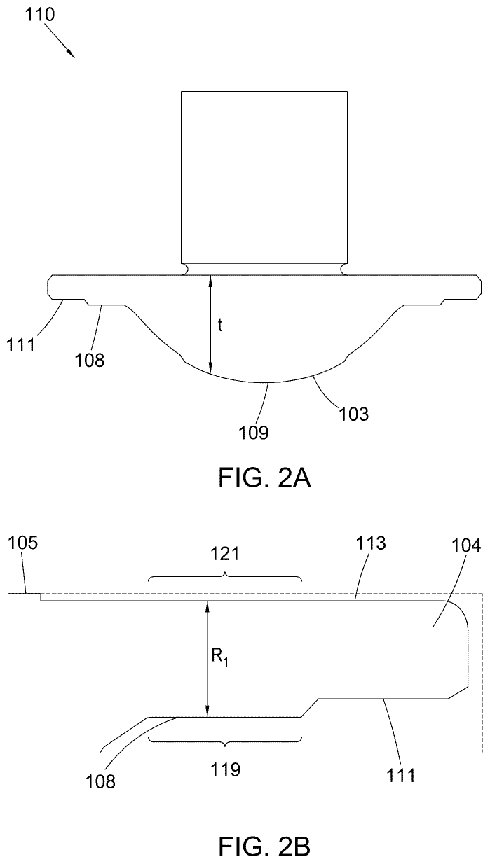

FIG. 2A shows a posterior lens member 110 formed by machining the front surface 103 of the lens member 100 of FIG. 1. Only those aspects of the posterior lens member 110 that differ with respect to the lens member 100 of FIG. 1 will be described here, and like elements are indicated with the same reference numerals as between FIG. 1 and FIG. 2A. The front surface 103 of the posterior lens member 110 comprises a convex surface region 109, a first planar surface region 108 and a second planar surface region 111. The convex surface region 109 is dome-shaped in FIG. 2A. The convex surface region 109 defines at least part of the optical zone of a lens. The convex surface region 109 is surrounded by the first planar surface region 108 which is annular when viewed in plan. The first planar surface region 108 is surrounded by the second planar surface region 111 which is annular when viewed in plan. The thickness t of the main body 104 decreases with distance from the longitudinal axis of the posterior lens member 110 (i.e. the main body 104 is thinnest at the second planar surface region 111).

FIG. 2B shows a close up of a region of the main body 104 of the posterior lens member 110. The rear surface 105 of the main body 104 comprises a third planar surface region 113 formed by removing material from the rear surface 105 of the main body 104. The shape of the main body 104 prior to machining is shown by a dashed line in FIG. 2B. A reference thickness R₁ is defined between third planar surface region 113 and first planar surface region 108, and the portions of first planar surface region 108 and third planar surface region 113 that are opposite each other constitute a first datum surface 119 and a second datum surface 121 respectively.

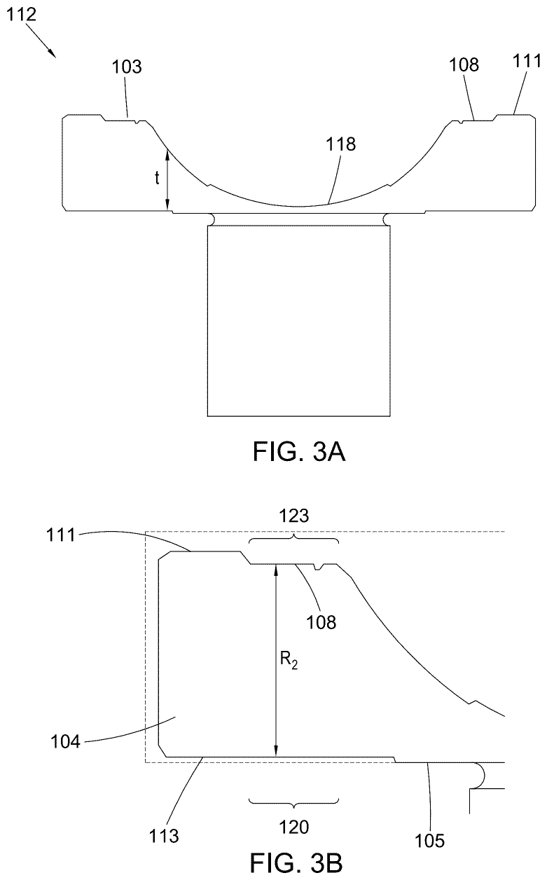

FIG. 3A shows an anterior lens member 112 formed by machining the front surface 103 of the lens member 100 of FIG. 1. Only those aspects of the anterior lens member 112 that differ with respect to the lens member of FIG. 1 will be described here, and like elements are indicated with the same reference numerals as between FIG. 1 and FIG. 3A. The front surface 103 of the anterior lens member 112 comprises a concave surface region 118, a first planar surface region 108 and a second planar surface region 111. The concave surface region 118 is bowl-shaped in FIG. 3A. The concave surface region 118 defines at least part of the optical zone of a lens. The concave surface region 118 is surrounded by the first planar surface region 108 which is annular when viewed in plan. The first planar surface region 108 is surrounded by the second planar surface region 111 which is annular when viewed in plan. The thickness t of the main body 104 increases with distance from the longitudinal axis of the anterior lens member 112 (i.e. the main body 104 is thickest at the second planar surface region 111).

FIG. 3B shows a close up of a region of the main body 104 of the anterior lens member 112. The rear surface 105 of the main body 104 comprises a third planar surface region 113 formed by removing material from the rear surface 105 of the main body 104. The shape of the main body 104 prior to machining is shown by a dashed line in FIG. 3B. A reference thickness R₂ is defined between third planar surface region 113 and first planar surface region 108, and the portions of third planar surface region 113 and first planar surface region 108 that are opposite each other constitute a third datum surface 120 and a fourth datum surface 123 respectively.

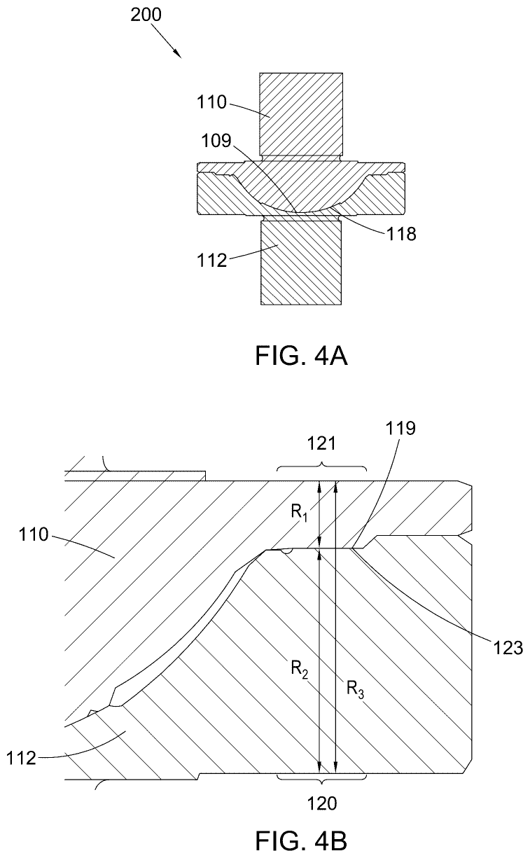

FIG. 4A shows a contact lens assembly 200 formed by bonding together the anterior lens member 112 of FIG. 2A and the posterior lens member 110 of FIG. 3A. The convex surface region 109 of the posterior lens member 110 is received in the concave surface region 118 of the anterior lens member 112. The shape of the blanks is unchanged from FIG. 2A and FIG. 3A. Like elements are indicated with the same reference numerals as between FIGS. 1 to 3A-B and FIG. 4A.

FIG. 4B shows a close up of a region of contact lens assembly 200 which shows the fourth datum surface 123 of the anterior lens member 112 touching the first datum surface 119 of posterior lens member 110. Thus, in FIG. 4B reference thickness R₁ is aligned with reference thickness R₂. In this way, the thickness of the contact lens assembly 200 is known as this point, and the thickness of the contact lens assembly at this point may be referred to as a third reference thickness R₃.

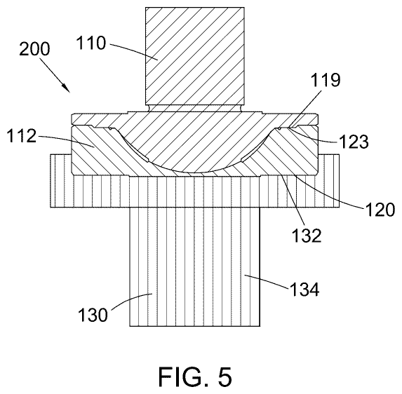

FIG. 5 shows the contact lens assembly 200 of FIGS. 4A and 4B after further machining steps. Like elements are indicated with the same reference numerals as between FIG. 1 to FIGS. 4A-B and FIG. 5. In FIG. 5, the spigot 102 of the anterior lens member 112 has been removed. The contact lens assembly 200 is mounted on a mandrel 130 with the third datum surface 120 of the anterior lens member 112 abutting the front surface 132 of the mandrel 130. The mandrel comprises a mandrel-spigot 134 which, in use, is received in the chuck of a lathe. It will be appreciated that in other embodiments, the spigot 102 of the posterior lens member 110 could be removed first, and the contact lens assembly 200 may be mounted on a mandrel 130 with the second datum surface 121 of the posterior lens member 110 abutting the front surface 132 of the mandrel 130, the following steps of the method would then be altered accordingly.

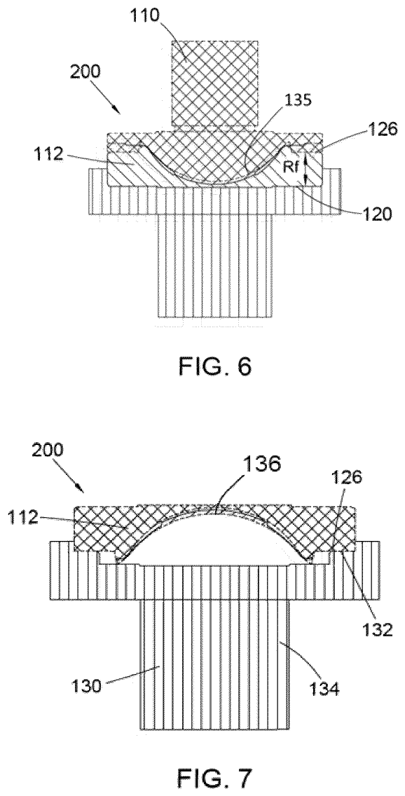

FIG. 6 shows the contact lens assembly 200 of FIG. 5 after further machining steps. Like elements are indicated with the same reference numerals as between FIG. 1 to FIG. 5 and FIG. 6. In FIG. 6, the posterior lens member 110 has been machined to remove its spigot 102 and provide its final shape. The original shape of the anterior lens member 112 and posterior lens member 110 is shown with cross-hatching in FIG. 6. The rear surface 105 of posterior lens member 110 comprises a concave surface region 135 that defines at least part of the optical zone of a lens. The thickness of the posterior lens member 110 has been very much reduced as compared to FIG. 5. It can also be seen that material has also been removed from the front surface 103 of the anterior lens member 112 to provide a sixth datum surface 126, a further reference thickness R_{f} being defined between sixth datum surface 126 and third datum surface 120.

FIG. 7 shows the contact lens assembly 200 of FIG. 6 after further machining steps. Like elements are indicated with the same reference numerals as between FIG. 1 to FIG. 6 and FIG. 7. In FIG. 7, the shape of the main body 104 of the anterior lens member 112 in FIG. 6 (i.e. prior to the further machining steps) is shown with cross-hatching. Prior to machining the contact lens assembly 200 is mounted on a mandrel 130 with the sixth datum surface 126 of the anterior lens member 112 abutting the front surface 132 of the mandrel 130. In FIG. 7, the anterior lens member 112 has been machined to provide its final shape. The rear surface 105 of the anterior lens member 112 comprises a convex surface region 136 that defines at least part of the optical zone of a lens.

The thickness of the anterior lens member 112 has been very much reduced as compared to FIG. 6.

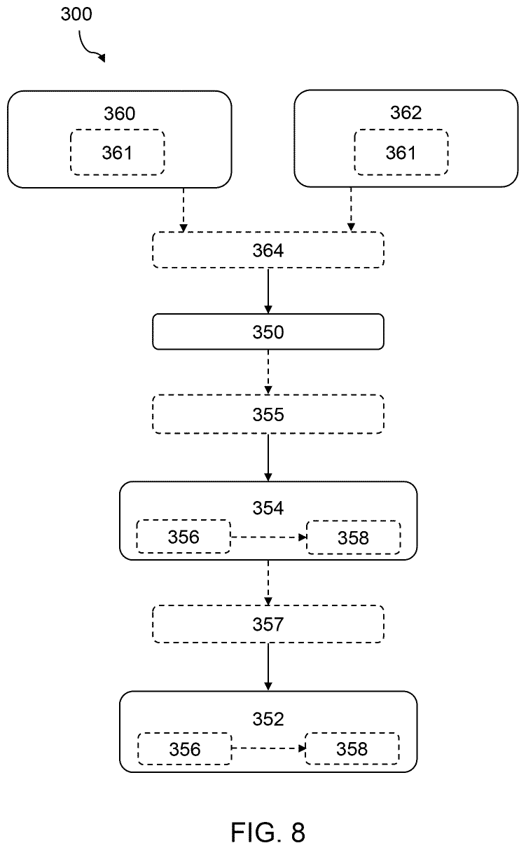

FIG. 8 is a flow chart showing a first example method 300 of manufacturing a contact lens assembly in accordance with the present disclosure. The method comprises bonding 350 the anterior surface of a first lens member to the posterior surface of a second lens member to form a contact lens assembly. After bonding 350, the method comprises machining 352 an anterior surface of the second lens member and machining 354 a posterior surface of the first lens member. The steps 352 and 354 can be carried out in any order. For example, in the method of FIG. 8, the step of machining 354 a posterior surface of the first lens member is carried out before the step of machining 352 an anterior surface of the second lens member. Optionally, the method comprises mounting 355 the contact lens assembly formed of the first and second lens members on a machine tool using the spigot of the second lens member and then machining 354 the posterior surface of the first lens member. Optionally, machining 354 the posterior surface of the first lens member comprises a course machining step 356 in which the spigot of the lens member is removed, for example using a non-optical lathe, and then a fine machining step 358 in which the surface of the lens member is cut to its final shape for example using an optical lathe. Once the step of machining 354 the posterior surface of the first lens member is complete, the method may optionally comprise mounting 357 the contact lens assembly formed of the first and second lens members on a mandrel, for example with the posterior surface of the first lens member adjacent the front surface of the mandrel, and then machining 352 the anterior surface of the second lens member. Optionally, machining 352 the anterior surface of the second lens member comprises a course machining step 356 in which the spigot of the lens member is removed, for example using a non-optical lathe, and then a fine machining step 358 in which the surface of the lens member is cut to its final shape, for example using an optical lathe. In embodiments in which the step of machining 352 the anterior surface of the second lens member is carried out before the step of machining 354 the posterior surface of the first lens member, then optionally the spigot of first lens member is used to mount the lens assembly while machining 352 the anterior surface of the second lens member, and the contact lens assembly is mounted with the anterior surface of the second lens member adjacent the front surface of the mandrel while machining 354 the posterior surface of the first lens member. Optionally, prior to bonding 350 the anterior surface of the first lens member to the posterior surface of the second lens member, the method may comprise machining 360 the anterior surface of the first lens member and/or machining 362 the posterior surface of the second lens member. It may be that the spigot of each lens member is used to mount said lens for machining. Optionally, machining 360 the anterior surface of the first lens member and/or machining 362 the posterior surface of the second lens member may comprise cutting 361 one or more diffractive optical elements into said surface. Optionally, prior to bonding 350 the anterior surface of the first lens member to the posterior surface of the second lens member the method may comprise applying 364 coatings and/or liquid fills (for example liquid crystal layers) to the anterior surface of the first lens member and/or the posterior surface of the second lens member.

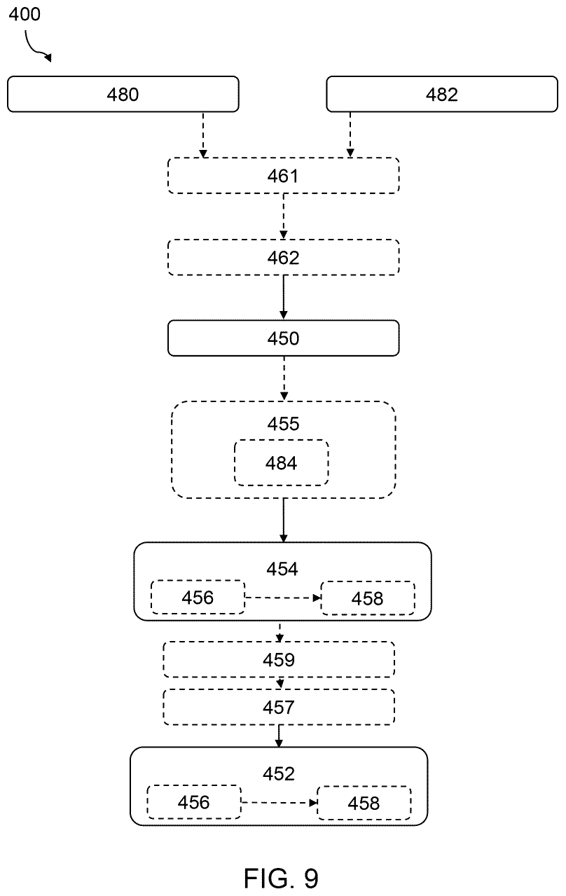

FIG. 9 is a flow chart showing a second example method 400 of manufacturing a contact lens assembly in accordance with the present disclosure. The method comprises machining 480 the anterior and posterior surface of a first lens member to provide a first reference thickness, for example by machining the anterior and posterior surfaces without removing the first lens member from the collet of the lathe. The region of the anterior surface and the region of the posterior surface between which the reference thickness is defined may be referred to as anterior and posterior datum surfaces respectively. The method also comprises machining 482 the anterior and posterior surface of a second lens member to provide a second reference thickness, for example by machining the anterior and posterior surfaces without removing the second lens member from the collet of the lathe. The steps 480 and 482 can be carried out in parallel, or in series in any order. After the steps 480 and 482, the method comprises bonding 450 an anterior surface of the first lens member to a posterior surface of the second lens member. Optionally, the first and second lens members are bonded 450 with the anterior datum surface of the first lens member touching the posterior datum surface of the second lens member. After bonding 450, the method comprises machining 452 an anterior surface of the second lens member and/or machining 454 a posterior surface of the first lens member to produce the final shape of the contact lens assembly. The steps 452 and 454 can be carried out in any order. For example, in the method of FIG. 9, the step of machining 454 a posterior surface of the first lens member is carried out before the step of machining 452 an anterior surface of the second lens member. Optionally, the method comprises mounting 455 the contact lens assembly formed of the first and second lens members on a mandrel using the spigot of the second lens member and then machining 454 the posterior surface of the first lens member. The step of mounting 455 the contact lens assembly on the mandrel may comprise positioning 484 the lens assembly on the mandrel by abutting the anterior datum surface of the second lens member and a front surface of the mandrel. Optionally, machining 454 the posterior surface of the first lens member comprises a course machining step 456 in which the spigot of the lens member is removed, for example using a non-optical lathe, and then carrying out a fine machining step 458 in which the surface of the lens member is cut to its final shape for example using an optical lathe. Optionally, the step of machining 454 the posterior surface of the first lens member comprises removing the entire thickness of the lens member, and then material is also removed 459 from the posterior surface of the second lens member while the contact lens assembly is still mounted on the machine tool, to produce a new posterior datum surface on the second lens member. Once the step of machining 454 the posterior surface of the first lens member is complete, (and optionally after removing 459 material from the posterior surface of the second lens member) the method may optically comprise mounting 457 the contact lens assembly formed of the first and second lens members on a mandrel, for example with an anterior datum surface of the first lens member or a posterior datum of the second lens member abutting the front surface of the mandrel, and then machining 452 the anterior surface of the second lens member. Optionally, machining 452 the anterior surface of the second lens member comprises a course machining step 456 in which the spigot of the lens member is removed, for example using a non-optical lathe, and then carrying out a fine machining step 458 in which the surface of the lens member is cut to its final shape, for example using an optical lathe. In embodiments in which the step of machining 452 the anterior surface of the second lens member is carried out before the step of machining 454 the posterior surface of the first lens member, then optionally the spigot of first lens member is used to mount the lens assembly with the posterior datum surface of the first lens member abutting the front surface of the mandrel while machining 452 the anterior surface of the second lens member is carried out, and the contact lens assembly is mounted with an anterior datum surface of the first or second lens member abutting the front surface of the mandrel while machining 454 the posterior surface of the first lens member. Optionally, the method may further comprise cutting 461 one or more diffractive optical elements and/or applying 462 coatings and/or liquid fills prior to bonding 450, as described above.

Whilst the present disclosure has been described and illustrated with reference to particular embodiments, it will be appreciated by those of ordinary skill in the art that the disclosure lends itself to many different variations not specifically illustrated herein.

Where in the foregoing description, integers or elements are mentioned which have known, obvious or foreseeable equivalents, then such equivalents are herein incorporated as if individually set forth. Reference should be made to the claims for determining the true scope of the present disclosure, which should be construed so as to encompass any such equivalents. It will also be appreciated by the reader that integers or features of the disclosure that are described as preferable, advantageous, convenient or the like are optional and do not limit the scope of the independent claims. Moreover, it is to be understood that such optional integers or features, whilst of possible benefit in some embodiments of the disclosure, may not be desirable, and may therefore be absent, in other embodiments.

1. A method of manufacturing a contact lens assembly, the method comprising: bonding an anterior surface of a first lens member to a posterior surface of a second lens member; and then machining an anterior surface of the second lens member and a posterior surface of the first lens member.

2. The method according to claim 1, further comprising machining the anterior surface of the first lens member and the posterior surface of the second lens member, before bonding the anterior surface of the first lens member to the posterior surface of the second lens member.

3. The method according to claim 1, wherein each of the first and second lens members comprise a spigot, and the step of machining an anterior surface of the second lens member and a posterior surface of the first lens member comprises removing the spigot of the first lens member and/or the spigot of the second lens member respectively.

4. The method according to claim 3, wherein the step of removing the spigot of the first lens member is carried out on different apparatus from the step of machining the posterior surface of the first lens member and/or the step of removing the first and/or the step of removing the spigot of the second lens member is carried out on different apparatus from the step of machining the anterior surface of the second lens member.

5. The method according to claim 1, wherein the method further comprises bonding the anterior surface of the first lens member to the posterior surface of the second lens member; and then mounting the first and second lens members so bonded on a mandrel, before the step of machining the anterior surface of the second lens member and the posterior surface of the first lens member is carried out.

6. The method according to claim 1, wherein the step of machining the anterior surface of the second lens member and the posterior surface of the first lens member comprises machining the posterior surface of the first lens member and then machining the anterior surface of the second lens member.

7. A method of manufacturing a contact lens assembly, the method comprising the steps of:
machining a region of an anterior surface of a first lens member to produce a first datum surface and machining a region of a posterior surface of the first lens member to provide a second datum surface, the first and second datum surfaces defining between them a first reference thickness; and
machining a region of an anterior surface of a second lens member to produce a third datum surface and machining a region of a posterior surface of the second lens member to provide a fourth datum surface, the third and fourth datum surfaces defining between them a second reference thickness; and
bonding an anterior surface of the first lens member to a posterior surface of the second lens member to produce a contact lens assembly; and then
machining the anterior surface of the second lens member and/or the posterior surface of the first lens member.

8. The method of claim 7, wherein machining of the anterior surface of the second lens member post-bonding is carried out while the contact lens assembly is mounted on a mandrel with the second datum surface abutting a front surface of the mandrel.

9. The method of claim 7, wherein machining of the posterior surface of the first lens member post-bonding is carried out while the contact lens assembly is mounted on a mandrel with the third datum surface abutting a front surface of the mandrel.

10. The method of claim 7, wherein the first lens member remains in place on the same machine tool throughout the steps of machining a region of the anterior surface of a first lens member to produce a first datum surface and machining a region of a posterior surface of the first lens member to provide a second datum surface.

11. The method of claim 7, wherein the second lens member remains in place on the same machine tool throughout the steps of machining a region of an anterior surface of a second lens member to produce a third datum surface and machining a region of a posterior surface of the second lens member to provide a fourth datum surface.

12. The method of claim 7, wherein the anterior surface of the first lens member is bonded to the posterior surface of the second lens member such that the first reference thickness and second reference thickness are aligned to define a third reference thickness between the second datum surface and the third datum surface.

13. The method of claim 12, wherein the anterior surface of the first lens member is bonded to the posterior surface of the second lens member with the first datum surface contacting the fourth datum surface.

14. The method of claim 7, wherein the first, second, third and/or fourth datum surfaces are annular when viewed in plan when first machined.

15. A contact lens assembly manufactured according to the method of claim 1.

16. The contact lens assembly according to claim 15, wherein the first and second lens members are polymethyl methacrylate lens members.

17. A first lens member having a first datum surface and a second datum surface, said datum surfaces being machined surfaces and defining between them a first reference thickness and/or a second lens member having a third datum surface and a fourth datum surface, said datum surfaces being machined surfaces and defining between them a second reference thickness.

18. A contact lens assembly comprising first and second lens members according to claim 17, wherein said first and second reference thickness are aligned to provide a third reference thickness of the contact lens assembly.
